(19) United States
(12) Patent Application Publication
(10) Pub. No.: US 2011/0045135 A1
(43) Pub. Date: Feb. 24, 2011

(54) PROCESSED SOYBEAN FOOD AND METHOD OF PRODUCING THE SAME

(75) Inventors: Kohei Mase, Aichi (JP); Kenji Yamamoto, Aichi (JP)

Correspondence Address: GREENBLUM & BERNSTEIN, P.L.C., 1950 ROLAND CLARKE PLACE, RESTON, VA, 20191, US

(73) Assignee: MASE TOFU MACHINE CO., LTD., Aichi (JP)

(21) Appl. No.: 12/990,716

(22) PCT Filed: May 29, 2008
(86) PCT No.: PCT/JP2008/059884

§ 371 Date: Nov. 2, 2010

(51) Int. Cl. A23L 1/20

(52) U.S. Cl. 426/46; 426/634

(57) ABSTRACT

Soy milk having a concentration of 10% to 15% is mixed with coagulant agent liquid that is obtained by dissolving a coagulant agent in warm water that is in an amount of 0.5 to 1.5 times a volume of the soy milk to obtain a curd. The coagulant agent coagulates protein contained in the soy milk. Thus obtained curd is dehydrated so that its water content to mass of the whole curd is within a range from 60% to 72% to obtain a processed soybean food of the present invention. In the present invention, the coagulant agent contains a compound selected from a group consisting of magnesium chloride and calcium chloride in a ratio of 0.2% to 0.5% of mass of the soy milk.

### TECHNICAL FIELD

The present invention relates to a processed soybean food and a method of producing the same.

### BACKGROUND ART

Processed soybean foods such as bean curd (tofu) contain protein and fat having a high rate of unsaturated fatty acid such as linoleic acid or linolenic acid and have a small cholesterol content. Owing to recent health concerns, the demand for the processed soybean foods is rising in Japan and Western countries.

Because of such a situation, the processed soybean foods are widely used with meat or a substitute food for meat, for example, used for filling of hamburgers, steak (see Patent Document 1), fried foods and deep-fried foods.

Cotton tofu that is one of the processed soybean foods is produced by the following method, for example.

Soy milk is obtained from a soy material by the known method and the hot soy milk is poured into a coagulation container. Then, a coagulant agent such as bitten (magnesium chloride) that is dissolved in a small amount of warm water is put therein and the mixture is stirred so that the coagulant agent is mixed with the soy milk evenly. After the mixture is left for a predetermined time, the protein contained in the soymilk is coagulated and curds are obtained. Next, the curds are broken and pressed in a tofu mold to discharge “yu” (that is extra water and oil) therefrom, and accordingly cotton tofu is produced.

[Patent Document] Japanese Unexamined Patent Publication No. 5-111361

### DISCLOSURE OF THE INVENTION

### Problem to be Solved by the Invention

In most cases, cotton tofu produced by the above method is cut into pieces each having a predetermined size and each piece is packed in a packaging container to be sold. When the cotton tofu is taken out of the packaging container to be placed on a dish, tofu is naturally drained. If the cotton tofu is used for various dishes, the tofu is drained and therefore flavor is hardly penetrated into the tofu. This makes dishes sloppy.

Further, general tofu is soft and easily crashed and therefore there has been need for hard tofu.

The present invention was made in view of the foregoing circumstances. An object of the present invention is to provide a processed soybean food that is hard and less likely to be drained.

### Means for Solving the Problem

The present invention relates to a processed soybean food comprising soy milk having a concentration of 10% to 15%, and coagulant agent liquid. The coagulant agent liquid includes a coagulant agent and is generated by dissolving the coagulant agent in warm water that is in an amount of 0.5 to 1.5 times a volume of the soy milk. The coagulant agent coagulates protein contained in the soy milk and contains a compound selected from a group consisting of magnesium chloride and calcium chloride in a ratio of 0.2% to 0.5% of mass of the soy milk. A curd is obtained by mixing the soy milk with the coagulant agent liquid and the processed soybean food is obtained by dehydrating the obtained curd so that its water content to mass of the whole curd is within a range from 60% to 72%.

In the present invention, the concentration of soy milk represents a percentage of a solid content to the total mass of soy milk.

The present invention also relates to a method of producing a processed soybean food comprising steps of pouring soy milk having a concentration of 10% to 15% into coagulant agent liquid that is obtained by dissolving a coagulant agent in warm water that is in an amount of 0.5 to 1.5 times a volume of the soy milk to obtain a curd. The coagulant agent coagulates protein contained in the soy milk and contains a compound selected from a group consisting of magnesium chloride and calcium chloride in a ratio of 0.2% to 0.5% of mass of the soy milk. The method further comprises a step of dehydrating the curd so that its water content to mass of the whole curd is within a range from 60% to 72%, after the pouring step.

General cotton tofu is produced by dissolving the coagulant agent into a small amount of warm water and mixing it with soy milk of high temperature. Such hard tofu has a high water content (approximately 80% to 90% in mass of the tofu) and has soft texture. The reasons of this will be described below.

In the general method of producing cotton tofu, the concentration of soy milk in the mixture of the coagulant agent and soy milk is relatively high. This makes relatively large blocks when protein in the soy milk is coagulated. The blocks are gathered into one curd with each of which containing water therein. There also exists water between the blocks of the curd and therefore the whole one curd contains a large amount of water. When the curd is pressed to be dehydrated, water existing between the blocks is removed and water contained in each block is hardly removed. As a result, the curd after pressing is soft and has a high water content.

According to the present invention, a coagulant agent having fast coagulation reaction with protein is used and after the coagulant agent is dissolved in warm water that is in an amount of 0.5 to 1.5 times the volume of soy milk, the coagulant agent is mixed with soy milk.

Therefore, according to the present invention, the concentration of soy milk in the mixture of soy milk and the coagulant agent is considerably lowered compared to that obtained by the general method of producing cotton tofu. As a result, the coagulant agent having fast coagulation reaction is dispersed in the diluted soy milk and promptly reacts with the protein contained in the soy milk. This makes the coagulant agent to be coagulated into small particles and precipitated.

According to the present invention, the concentration of soy milk is lowered by mixing the soy milk with the coagulant agent that is dissolved in a predetermined amount of warm water. This increases the amount of the coagulant agent relative to the soy milk and a part of the coagulant agent is discharged with water from the particles of the curd that are generated by the reaction with protein. After a predetermined coagulation time has passed, the small particles are accumulated to generate the curd, and water and oil that are not contained in the curd is separated therefrom and produced on the generated curd.

It is preferable to produce processed soybean foods of the present invention by the method of pouring soy milk into the coagulant agent liquid obtained by dissolving the coagulant agent with a predetermined amount of warm water. According to the above method, after soy milk is poured into the coagulant agent liquid, the soy milk is instantly dispersed in the coagulant agent liquid and protein is coagulated into small particles.

If thus generated curd is dehydrated so that its water content becomes within a range from 60% to 72%, water between the small particles is removed and the particles are further hardened. Accordingly, a processed soybean food that is hard and less likely to be drained is obtained.

The present invention may have following configurations.

(1) The processed soybean food that is obtained by pressurizing and dehydrating the curd according to the present invention is preferable, since water between the small particles is removed and the particles are further hardened so that processed soybean foods having a precise organization structure is easily obtained.

It is more preferable that the curd is pressurized and dehydrated with applying pressure of 0.4 MPa to 0.5 MPa, because this shortens a dehydration time.

(2) Processed soybean food of the present invention may be obtained with being processed with a freezing process after dehydrating the curd.

Processed soybean food of the present invention produced without being processed with the freezing process is hardly drained.

The present inventor recognizes that the processed soybean food that is produced with being processed with the freezing process after dehydration has a remarkable effect of holding water therein compared to the processed soybean food produced without being processed with the freezing process.

It is preferable to produce processed soybean food by the above method since thus produced processed soybean food is remarkably less likely to be drained.

(3) Processed soybean food according to the present invention having a water separation rate of 8% or less is preferable because flavor is likely to be penetrated into the processed soybean food and thus produced processed soybean food is applicable to various dishes.

In the present invention, the water separation rate (%) is expressed in percentage by representing a proportion of supernatant solution (liquid) obtained after centrifugal separation of the processed soybean food [9.80*10⁴ m/S² (10,000*g) for ten minutes] to the mass of the processed soybean food.

### EFFECTS OF THE INVENTION

The present invention provides a processed soybean food that is hard and less likely to be drained.

### BEST MODE FOR CARRYING OUT THE INVENTION

A processed soybean food of the present invention is obtained by the following method. Soy milk is mixed with coagulant agent liquid that is obtained by dissolving a coagulant agent into a predetermined amount of warm water to obtain a curd. The curd is dehydrated so that a water content to the mass of the whole curd is within a range from 60% to 72%.

Soy milk obtained by a known method is used in the present invention. In the present invention, soy milk having a concentration of 10% to 15% that is measured by a soy milk concentration meter (refractometer) is used, and especially soy milk having a concentration of 11% to 13% is preferable. If soy milk having a concentration of less than 10% is used, the particles of the curd become too small and the obtained processed soybean food is excessively hardened. If soy milk having a concentration of more than 15% is used, the curd of a relatively large block is generated and the obtained processed soybean food is soft and has a high water content like cotton tofu produced by the general method.

The coagulant agent that coagulates protein contained in soy milk and has fast coagulation reaction is used in the present invention. Specifically, a coagulant agent selected from a group consisting of a coagulant agent containing magnesium chloride (magnesium chloride, bittern) and a coagulant agent containing calcium chloride is used in the present invention.

The coagulant agent maybe selected with considering an intended purpose and preference of consumers. If bittern is used as the coagulant agent for example, a processed soybean food having good flavor is obtained, and if calcium chloride is used as the coagulant agent, the obtained processed soybean food is harder than the one obtained with using bittern.

In the present invention, the coagulant agent is used so that the proportion of a compound selected from a group consisting of magnesium chloride and calcium chloride contained in the coagulant agent in the mass of soy milk is 0.25% to 0.50. If the amount of the coagulant agent is less than the above range, coagulation is less likely to be caused, and if the amount of the coagulant agent is more than the above range, coagulation may not be caused evenly or the obtained processed soybean food may be bitter.

In the present invention, after the coagulant agent is dissolved in warm water that is in an amount of 0.5 to 1.5 times the volume of soy milk to obtain coagulant agent liquid, the coagulant agent liquid is mixed with soy milk. The warm water having the above amount is used in the present invention due to the following reasons.

If warm water of an amount less than the above range is used, the curd of a relatively large block is generated and a processed soybean food that is soft and has a large water content like cotton tofu produced by a general method is obtained. If warm water of an amount more than the above range is used, the particle of the curd becomes too small and the obtained processed soybean food becomes hardened excessively.

The coagulant agent liquid and soy milk are mixed with each other by pouring soy milk into the coagulant agent liquid or pouring the coagulant agent liquid into soy milk. It is preferable to obtain the mixture by pouring soy milk into the coagulant agent liquid, because soy milk is instantly dispersed in the coagulant agent liquid and protein is coagulated into small particles after soy milk is poured into the coagulant agent liquid.

When the coagulant agent liquid is mixed with soy milk, protein contained in the soy milk starts to be coagulated. It is preferable to set the temperature of warm water in which the coagulant agent is dissolved and the temperature of the soy milk before being mixed with the coagulant agent liquid so that the temperature of the mixture of the coagulant agent liquid and the soy milk is maintained in a range from 60 to 80 degrees C. during the coagulation process. If the mixture is maintained at a low temperature less than 60 degrees C. in the coagulation process, the curd may become in a paste form, and if the mixture is maintained at a high temperature more than 80 degrees C., the curd may lack of elasticity.

The curd is dehydrated so that the water content in the mass of the whole curd is in a range from 60% to 72% to obtain a processed soybean food of the present invention.

If the water content in the whole curd is less than 60%, the curd is easily adhered to a container used in dehydration. If the water content in the whole curd is more than 72%, the obtained processed soybean food becomes mushy when it is processed by a food processor to be used as a cooking ingredient and it is difficult to be cooked.

Cotton tofu that is generally available contains a large amount of water (80 to 90% in the total mass of tofu). Therefore, if cotton tofu is frozen, water contained in tofu becomes ice crystals and this makes the tofu to have sponge-like holes and lose the original texture of cotton tofu. Therefore, it is known that tofu is not suitable to be frozen and stored. Considering frozen storage of tofu, it is preferable to dehydrate the curd so that the water content in the whole curd is 70% or less.

In the present invention, dehydration of the curd is executed by any one of methods including a method of putting the curd in a water-passing container having a cloth therein and leaving them for a predetermined period (natural dehydration), a method of wrapping the curd in a cloth and squeezing them, a method of separating the curd by centrifugation, and a method of pressurizing the curd or a method combining two or more of the methods.

Among the methods, it is preferable that the curd is pressurized to be dehydrated (pressurizing dehydration), since water between the small particles of the curd is removed so that the particles are further hardened and a processed soybean food having a precise organization structure is obtained.

It is further preferable that the curd is put in a water-passing container and left for several minutes and thereafter the curd is pressurized and dehydrated by application of pressure of 0.4 MPa to 0.5 MPa thereto, since the curd having a predetermined water content is obtained in a short period (10 to 15 minutes).

In a general method of producing cotton tofu, if the pressure of the above range is applied to the curd from the beginning of pressurization at the time of pressurizing the curd in the container, the curd may be adhered to the container or may be crashed. Therefore, it is required that the pressure is reduced at the beginning and is gradually increased as time passes. As a result, it takes time until the curd is dehydrated so that the water content of the curd obtained in the general method of producing cotton tofu is substantially same as the water content of a processed soybean food of the present invention.

According to the present invention, the curd may be molded to make a molded product, or may not be molded. However, when the curd is molded to make a molded product, it is preferable to put the curd in a molding container and execute pressurizing dehydration since dehydration and molding are executed simultaneously.

According to the present invention, a processed soybean food produced without being processed with the freezing process is less likely to be drained. The present inventor found that if a processed soybean food is produced with the freezing process after dehydration, the produced processed soybean food is remarkably less likely to be drained compared to the one produced without the freezing process.

It is preferable to obtain a processed soybean food of the present invention by executing the freezing process since the obtained processed soybean food is remarkably less likely to be drained.

In the present invention, the method of freezing the curd is not limited. However, it is preferable that the curd is frozen by a quick freezing method, since loss of nutritional value or flavor is suppressed.

If general cotton tofu is used for cooking, tofu is drained and flavor is hardly penetrated into the tofu. This is caused by the high water content of the cotton tofu and the high water separation rate (approximately 12%).

It is preferable to set the water separation rate of a processed soybean food of the present invention to 8% or less, since the flavor is likely to be penetrated thereinto and the processed soybean food can be used for various dishes.

Operations and effects of the present invention will be explained below.

According to the present invention, a processed soybean food that is hard and less likely to be drained is obtained due to the following reasons.

In the present invention, since the coagulant agent having fast coagulation reaction with protein is dissolved in warm water that is in an amount of 0.5 to 1.5 times the volume of soy milk, the concentration of soy milk in the mixture of soy milk and the coagulant agent is considerably lowered. As a result, the coagulant agent is dispersed in the diluted soy milk and promptly reacts with protein contained in the soy milk. This makes the coagulant agent to be coagulated into small particles and precipitated.

In the present invention, the concentration of soy milk is lowered by mixing the soy milk with the coagulant agent that is dissolved in the above predetermined amount of warm water. This increases the amount of the coagulant agent relative to the soy milk and a part of the coagulant agent is discharged with water from the particles of the curd that is generated by the reaction with protein. After a predetermined coagulation time has passed, the small particles are accumulated to generate a curd, and water and oil that are not contained in the curd are separated therefrom and produced on the generated curd. If thus generated curd is dehydrated so that its water content is within a range from 60% to 72%, water between the small particles is removed and the particles are further hardened. Accordingly, a processed soybean food that is hard and less likely to be drained is obtained.

According to the present invention, as described above, water is discharged with the coagulant agent from the particles of the curd that is generated by the reaction with protein. Therefore, it takes short time for dehydrating the curd until its water content is reduced to the predetermined amount. As a result, a processed soybean food of the present invention is produced in a short time.

General cotton tofu is drained during cooking, dehydration of tofu (dehydration after producing tofu) is executed before cooking by placing a weight stone on the tofu and leaving them for a predetermined time, for example. A processed soybean food of the present invention is less likely to be drained, and therefore dehydration before cooking is not necessary. This shortens a cooking time.

A processed soybean food of the present invention is harder than general tofu, and therefore a processed soybean food of the present invention is hardly crashed during cooking. Also, since the remaining amount of the coagulant agent in the processed soybean food is small, the processed soybean food is almost tasteless and it can be flavored with various seasonings. Therefore, a processed soybean food of the present invention is used for various dishes including a fried food, a deep-fried food, a roasted food and a boiled food.

### EXAMPLES

The present invention will be explained in more detail with reference to EXAMPLES.

### Example 1

### (1) Producing Curd

Store 10 liters of warm water in a coagulation container, and dissolve 120 ml of bittern (trade name “Chatan Nigari”) in the warm water to produce coagulant agent liquid.

Next, 10 liters of soy milk having a concentration of 12% to 13% that is obtained by a known method is poured into the coagulant agent liquid to mix the coagulant agent liquid with the soy milk. Then, protein contained in the soy milk starts to be coagulated.

A temperature of the warm water and a temperature of the soy milk are set so that a temperature of the mixture of the coagulant agent liquid and the soy milk is maintained within a range from 60 to 80 degrees C. during the coagulating process. In this EXAMPLE, the amount of magnesium chloride in the mass of soy milk is 0.3%.

### (2) Dehydration of Curd

After leaving the mixture of the coagulant agent liquid and the soy milk for seven minutes, the curd is taken out of the mixture and put it on a cotton cloth placed in a colander and leave it for one minute to be drained naturally. Then, the curd is wrapped in a cloth and squeezed for several times to be dehydrated.

Next, the curd is pressurized with 0.45 MPa pressure for 10 minutes to obtain tofu (a processed soybean food of the present invention) of EXAMPLE 1.

### Example 2

Freeze tofu obtained in EXAMPLE 1 at minus 20 degrees C. in a refrigerator-freezer [manufactured by Advantec Toyo Kaisha LTD., THE051FA] for one night. Thereafter, leave the frozen tofu in a room of 20 degrees C. for two to three hours to be defrosted and tofu (a processed soybean food of the present invention) of EXAMPLE 2 is obtained.

### COMPARATIVE EXAMPLE

Commercially available cotton tofu (trade name “Nigari Tofu”: bittern is used as a coagulant agent) is an example of COMPARATIVE EXAMPLE 1. Tofu obtained by freezing and defrosting the tofu of COMPARATIVE EXAMPLE 1 on the same conditions as the tofu of EXAMPLE 2 is an example of COMPARATIVE EXAMPLE 2.

### TEST EXAMPLES

### (1) Analysis of Water Content

Each water content of the tofu of EXAMPLE 1 and the tofu of COMPARATIVE EXAMPLE 1 is analyzed by an atmospheric heating and drying method.

Each of tofu of EXAMPLE 1 and tofu of COMPARATIVE EXAMPLE 1 is drained in a colander for 30 minutes. Then, each tofu is homogenized at a rotational speed of 5000 by a homogenizer [NISSEI Excel autohomogenizer manufactured by NIHONSEIKI KAIASHA LTD.] and the obtained tofu is used as samples.

A constant mass value [W1 (g)] of the glass weighing dish on which silica sand (manufactured by KANTO SCIENCE CO., LTD.) is placed as a drying aid is previously obtained. The sample is placed on the glass weighing dish and the obtained weighing value is represented by W2 (g).

While the sample is mixed with the drying aid, the mixture is preliminarily dried with using a water bath and dried at 130 degrees C. by a drier [KS-6 manufactured by TOYO SCIENCE INDUSTRIES CO., LTD.] so as to have constant mass. The dried sample is left in a silica-gel desiccator for cooling down and weighed. The obtained weighing value is represented by W3 (g) and the water content is obtained as follows:

Water content (%)=100*(W2−W3)/(W2−W1)

### (2) Water Separation Rate

Each water separation rate of tofu of EXAMPLES 1 and 2 and tofu of COMPARATIVE EXAMPLES 1 and 2 is measured by the following method.

Each of the tofu of EXAMPLES 1 and 2 and the tofu of COMPARATIVE EXAMPLES 1 and 2 is cut into 1 cm dices to be prepared as samples. The mass (X1) of each sample is previously measured and each sample is centrifuged on the condition of 9.80*10⁴m/S² (10,000*g) for ten minutes by a centrifugal separator [7930 manufactured by Kubota Corporation]. The mass (X2) of supernatant solution obtained after the centrifugal separation is measured and the separation rate (%) is obtained as follows and the obtained values are illustrated in Table 1:

Separation rate (%)=100*X2/X1

### (3) Measurement of Stress at Rupture

Each of the tofu of EXAMPLE 2 and the tofu of COMPARATIVE EXAMPLE 2 is cut into 2 cm dices and prepared as samples. A stress at rupture of each sample is measured by a creep meter RE3305 manufactured by YAMADEN co., ltd. Specifically, a stress at rupture of each sample is measured by compressing each sample at a compression speed 1 mm/second with a columnar plunger having a diameter of 8 mm. Each sample is measured for eight times and an average value of the obtained values is computed. The results are illustrated in Table 1.

### (4) Penetration Test of Liquid Preparation

Samples are produced from the tofu of EXAMPLE 1 and the tofu of COMPARATIVE EXAMPLE 1 by the following method and an amount of sodium contained in 100 g (mg/100 g) of each sample is measured and analyzed.

(4-1) Producing Samples (4-1)

Each of the tofu of EXAMPLE 1 and the tofu of COMPARATIVE EXAMPLE 1 is cut into blocks each having a vertical size of approximately 10 cm, a horizontal size of approximately 5 cm and a height of 5 cm. Four cut tofu blocks of EXAMPLE 1 make a set and four cut tofu blocks of COMPARATIVE EXAMPLE 1 make another set and each set is immersed in 100 ml of liquid preparation [“Nibuta no Tare” produced by MATSUYA SAKAE SHOKUHIN-HONPO CO., LTD.] for half a day. Accordingly, samples (4-1) are obtained. The total mass of the four tofu blocks (before immersion in the liquid preparation) is approximately 180 g.

(4-2) Producing Samples (4-2)

180 g of each of the tofu of EXAMPLE 1 and the tofu of COMPARATIVE EXAMPLE 1 is crashed by a commercially available food cutter so that each crashed tofu piece has a maximum diameter of approximately 8 mm. Each of the crashed tofu of EXAMPLE 1 and the crashed tofu of COMPARATIVE EXAMPLE 1 is immersed in 100 ml of the liquid preparation [“Nibuta no Tare” produced by MATSUYA SAKAE SHOKUHIN-HONPO CO., LTD.] for half a day. Accordingly, samples (4-2) are obtained.

### (Analysis of Amount of Sodium Contained in Samples)

An amount of sodium (mg/100 g) contained in each of the samples (4-1) and the samples (4-2) is obtained and analyzed by atomic absorption spectrophotometry (extraction of hydrochloric acid).

20% hydrochloric acid for precise analysis is diluted in ion-exchange water to prepare solution containing 1% hydrochloric acid. The solution containing 1% hydrochloric acid is added to each sample to execute extraction of hydrochloric acid. Then, the absorbance of the extracted solution is measured by the atomic absorption spectrophotometer [polarized Zeeman atomic absorption spectrophotometer Z-2000 manufactured by Hitachi, Ltd.] [according to the atomic absorption spectrophotometry (extraction of hydrochloric acid) on conditions that the wavelength is 589 nm and acethylene-air flame is used, that is adapted from “Food Sanitation Inspection Guideline, physics and chemistry edition, 2005”].

The amount of sodium (mg/100 g) obtained by the above analysis is multiplied by 2.54*10⁻³ to obtain a sodium chloride equivalent (g/100 g) and the obtained values are illustrated in Table 1.

The amount of sodium contained in each of the tofu blocks of EXAMPLE 1 and COMPARATIVE EXAMPLE 1 before immersion in the preparation liquid is analyzed according to the above analysis method. The analysis results are illustrated in “Na amount before immersion” in Table 1.

In Table 1, (4-1) Na amount represents a sodium amount in each of the samples (4-1), (4-1) sodium chloride equivalent represents a sodium chloride equivalent in each of the samples (4-1), (4-2) Na amount represents a sodium amount in each of the samples (4-2), and (4-2) sodium chloride equivalent represents a sodium chloride equivalent in each of the samples (4-2).

(Results and Review)

TABLE 1

| | | | COMPARATIVE | COMPARATIVE |
|---|---|---|---|---|
| | EXAMPLE 1 | EXAMPLE 2 | EXAMPLE 1 | EXAMPLE 2 |
| Water content (mass %) | 67.1 | — | 82.4 | — |
| Water separation rate (%) | 7.3 | 0.3 | 12.2 | 13.8 |
| Stress at rupture (kPa) | 336.2 | — | 73.5 | — |
| Na amount before | 12 | — | 18 | — |
| immersion (mg/100 g) | | | | |
| (4-1) Na amount (mg/100 g) | 790 | — | 730 | — |
| (4-1) sodium chloride | 2.0 | — | 1.9 | — |
| equivalent (g/100 g) | | | | |
| (4-2) Na amount (mg/100 g) | 810 | — | 630 | — |
| (4-2) sodium chloride | 2.1 | — | 1.6 | — |
| equivalent (g/100 g) | | | | |

The following is recognized from the results illustrated in Table 1.

(1) The tofu of Example 1 (product of the present invention) has the water content and the water separation rate lower than the tofu of COMPARATIVE EXAMPLE 1 (comparative product). The tofu of EXAMPLE 1 has stress at rupture that is four times or more of the tofu of COMPARATIVE EXAMPLE 1. Accordingly, it is recognized that the processed soybean food of the present invention has a lower water content and is less likely to be drained and harder compared to general cotton tofu.

It is thought that this is caused by the following reasons.

When the tofu of EXAMPLE 1 is produced, soy milk is poured into the coagulant agent liquid that is obtained by dissolving the coagulant agent with warm water having an amount same as the volume of the soy milk. Therefore, the concentration of the soy milk is extremely lowered in the mixture of the soy milk and the coagulant agent liquid. In the mixture having a lowered concentration of the soy milk, the soy milk is mixed with the coagulant agent having fast coagulating reaction and instantly dispersed in the coagulant agent liquid. As a result, the coagulant agent is dispersed in the diluted soy milk and reacts with protein contained in the soy milk. This makes the coagulant agent to be coagulated into small particles and precipitated.

In EXAMPLE 1, since the soy milk is mixed with the coagulant agent that is dissolved in warm water of the above amount, the concentration of the soy milk in the mixture is lowered. This increases the amount of the coagulant agent relative to the soy milk in the mixture. A part of the coagulant agent is discharged with water from the particles of the curd that is generated by the reaction with protein. After a predetermined coagulation time has passed, the small particles are accumulated to generate the curd, and the water and oil that are not contained in the curd are separated therefrom and produced on the generated curd. If thus generated curd is dehydrated, water between the small particles is removed and the particles of the curd are further hardened. As a result, tofu that is hard and has a low water content and a low separation rate is obtained.

(2) Comparing the tofu of COMPARATIVE EXAMPLE 1 and the tofu of COMPARATIVE EXAMPLE 2, the tofu of COMPARATIVE EXAMPLE 2 obtained by being processed with the freezing and defrosting process has a higher water separation rate. However, comparing the tofu of EXAMPLE 1 and the tofu of EXAMPLE 2, the tofu of EXAMPLE 2 obtained by being processed with the freezing and defrosting process has an extremely low separation rate.

From the above results, in the present invention, it is preferable to produce a processed soybean food by being processed with the freezing process since the thus produced food has a low separation rate.

(3) Comparing the Sodium contents of the tofu of EXAMPLE 1 and the tofu of COMPARATIVE EXAMPLE 1 before immersion in the liquid preparation, the tofu of EXAMPLE 1 has a lower Sodium content than the tofu of COMPARATIVE EXAMPLE 1.

However, comparing the tofu of EXAMPLE 1 and the tofu of COMPARATIVE EXAMPLE 1 after immersion in the liquid preparation, as to both of the samples (4-1) and (4-2), the tofu of EXAMPLE 1 has a greater Sodium content than the tofu of COMPARATIVE EXAMPLE 1. Thus, it is recognized that flavor is likely to penetrate into a processed soybean food of the present invention compared to the general cotton tofu.

(4) Among the tofu after immersion in the liquid preparation, the Sodium contents of the samples (4-1) and (4-2) are compared.

As a result, in the tofu of EXAMPLE 1, the samples (4-2) have a greater Sodium amount than the samples (4-1), however, in the tofu of COMPARATIVE EXAMPLE 1, the samples (4-1) have a greater Sodium amount than the samples (4-2).

In the tofu of EXAMPLE 1, it is thought that the crashed sample has a greater area contacting the liquid preparation than the cut sample, and therefore the flavor easily penetrates into the crashed tofu. In the tofu of COMPARATIVE EXAMPLE 1 also, the crashed sample has a greater area contacting the liquid preparation than the cut sample, however, the sample is crashed into small pieces. This makes the tofu easy to be drained and the flavor is less likely to penetrate into the tofu.

### Other Embodiments

The present invention is not limited to the above embodiments explained in the above description. The following embodiments may be included in the technical scope of the present invention, for example.

(1) In the above embodiments, the curd is pressurized to be dehydrated, however, it may be dehydrated by centrifugal separation.

(2) In the above embodiments, the coagulant agent is dissolved in warm water that is in an amount of the same volume as the soymilk to obtain the coagulant agent liquid. However, the amount of warm water may be 0.5 times the volume of the soy milk or may be 1.5 times the volume of the soy milk.

1. A processed soybean food comprising:
soy milk having a concentration of 10% to 15%; and
coagulant agent liquid including a coagulant agent and being generated by dissolving the coagulant agent in warm water that is in an amount of 0.5 to 1.5 times a volume of the soy milk, the coagulant agent coagulating protein contained in the soy milk and containing a compound selected from a group consisting of magnesium chloride and calcium chloride in a ratio of 0.2% to 0.5% of mass of the soy milk,
wherein a curd is obtained by mixing the soy milk with the coagulant agent liquid and the processed soybean food is obtained by dehydrating the obtained curd so that its water content to mass of the whole curd is within a range from 60% to 72%.

2. The processed soybean food according to claim 1, wherein the processed soybean food is obtained by pressurizing and dehydrating the curd.

3. The processed soybean food according to claim 2, wherein the processed soybean food is obtained by applying pressure of 0.4 MPa to 0.5 MPa to the curd to dehydrate the curd.

4. The processed soybean food according to claim 1, wherein the processed soybean food is obtained by being processed with a freezing process after dehydration of the curd.

5. The processed soybean food according to claim 1, wherein the processed soybean food has a water separation rate of 8% or less.

6. The processed soybean food according to claim 4, wherein the processed soybean food has a water separation rate of 8% or less.

7. A method of producing a processed soybean food comprising steps of:
pouring soy milk having a concentration of 10% to 15% into coagulant agent liquid that is obtained by dissolving a coagulant agent in warm water that is in an amount of 0.5 to 1.5 times a volume of the soy milk to obtain a curd, the coagulant agent coagulating protein contained in the soy milk and containing a compound selected from a group consisting of magnesium chloride and calcium chloride in a ratio of 0.2% to 0.5% of mass of the soy milk; and
after the pouring step, dehydrating the curd so that its water content to mass of the whole curd is within a range from 60% to 72%.

8. The method of producing a processed soybean food according to claim 7, wherein the curd is pressurized and dehydrated.

9. The method of producing a processed soybean food according to claim 8, wherein the curd is dehydrated by applying pressure of 0.4 MPa to 0.5 MPa thereto.

10. The method of producing a processed soybean food according to claim 7, wherein the curd is frozen after dehydration.

11. The processed soybean food according to claim 2, wherein the processed soybean food is obtained by being processed with a freezing process after dehydration of the curd.

12. The processed soybean food according to claim 11, wherein the processed soybean food has a water separation rate of 8% or less.

13. The processed soybean food according to claim 3, wherein the processed soybean food is obtained by being processed with a freezing process after dehydration of the curd.

14. The processed soybean food according to claim 13, wherein the processed soybean food has a water separation rate of 8% or less.

15. The processed soybean food according to claim 2, wherein the processed soybean food has a water separation rate of 8% or less.

16. The processed soybean food according to claim 3, wherein the processed soybean food has a water separation rate of 8% or less.

17. The method of producing a processed soybean food according to claim 8, wherein the curd is frozen after dehydration.

18. The method of producing a processed soybean food according to claim 9, wherein the curd is frozen after dehydration.
